(19) United States
(12) Patent Application Publication
(10) Pub. No.: US 2025/0070901 A1
(43) Pub. Date: Feb. 27, 2025

(54) METHOD FOR COMMUNICATION TO A PLURALITY OF RECEIVERS, CORRESPONDING EMITTER AND COMPUTER PROGRAM

(71) Applicant: Orange, Issy-Les-Moulineaux (FR)

(72) Inventors: Raphaël VISOZ, Chatillon Cedex (FR); Rita IBRAHIM, Chatillon Cedex (FR)

(21) Appl. No.: 18/723,381

(22) PCT Filed: Dec. 20, 2022
(86) PCT No.: PCT/EP2022/086866

§ 371 Date: Jun. 21, 2024

(30) Foreign Application Priority Data
Dec. 23, 2021 (FR) FR2114466

(51) Int. Cl. H04B 17/382; H04B 7/0452; H04B 17/345

(52) U.S. Cl. CPC H04B 17/382; H04B 7/0452; H04B 17/345

(57) ABSTRACT

A communication method is implemented in a transmission system comprising an emitter and a set of receivers. The method comprises, for at least one time-frequency resource, receiving, from each of the receivers, at least one piece of information relating to a technique for acquiring knowledge of the transmit channel. At least one of said receivers is configured to return to said emitter information relating to a first technique for acquiring knowledge of the transmit channel. At least one of said receivers is configured to return to said emitter information relating to a second technique for acquiring knowledge of the transmit channel. The method further comprises the selection, from said information received from the receivers, of a subset of receivers, included in the set of receivers, to which the emitter is configured to emit data on said at least one time-frequency resource.

### CROSS-REFERENCE TO RELATED APPLICATIONS

This application is filed under 35 U.S.C. § 371 as the U.S. National phase of application No. PCT/EP2022/086866 entitled “METHOD FOR COMMUNICATION TO A PLURALITY OF RECEIVERS, CORRESPONDING EMITTER AND COMPUTER PROGRAM” and filed Dec. 20, 2022, and which claims priority to FR 2114466 filed Dec. 23, 2021, each of which is incorporated by reference in its entirety.

### FIELD

The development relates to the field of wireless communications.

More precisely, the development proposes a technique allowing to optimize the formation of beams obtained from an array of antennas, so as to improve the transmission of information between an emitter and several receivers, uplink and downlink.

The development finds applications in any beamforming-based system, in particular in radio communication networks according to the 4G or 5G standards defined by the 3GPP, WiFi communication networks according to the various IEEE 802.11 standards, etc.

For downlink communication, the emitter can be a base station, for example of the eNodeB (“evolved Node B”) type for networks based on LTE or LTE Advanced technologies, or a Wi-Fi access point, etc. A receiver can in turn be a terminal such as a smartphone, tablet, connected object, etc. For uplink communication, the emitter can be a terminal, and the receiver a base station.

### PRIOR ART

Beamforming, or precoding, is a signal processing technique used in antenna or sensor arrays for directional transmission or reception of signals. In other words, thanks to antenna arrays, emitters and/or receivers can focus the radiation of the emitted wave in a particular direction, which allows to obtain spatial selectivity.

Beamforming is carried out by combining the elements of a phase and amplitude controlled antenna array so that:
the signals are combined constructively in particular directions, resulting in an increase in the useful power received,
the signals are combined destructively in the other directions, resulting in a reduction in the interference power received.

Thus, for the formation of beams at an emitter towards a single receiver, a complex coefficient, called precoding coefficient, is applied to each element of the antenna array of the emitter. All these coefficients form a precoding matrix.

Note that for the radiation pattern to be oriented in the desired direction, the precoding coefficients must be correctly chosen. The better the precoding chosen, the better the transmission will be. The fundamental problem for the selection of this precoding is the acquisition of knowledge of the transmit channel or “transmit Channel State Information” (CSI). Knowledge of the transmit channel, means, within the meaning of information theory, the knowledge of the channel in the direction from emitter to receiver and of the statistics of the interference in reception.

Currently, two techniques for acquiring knowledge of the transmit channel are proposed for MIMO systems in the 4G, 5G, IEEE 802.11x (IEEE 802.11n, 802.11ac, 802.11ax) standards: a technique based on use of a precoding dictionary (“codebook”) and a technique based on channel reciprocity. The techniques for acquiring channel awareness, and the associated reference signals, are described more precisely in the 3GPP specifications TS36.213, TS36.211 for 4G and TS38.211, TS38.214 for 5G.

The first technique based on the use of a precoding dictionary, denoted CSI-D, is based on the use of a limited return path between the receiver and the emitter, and on the precoding dictionary (hence the “D” of CSI-D, for dictionary).

According to this CSI-D technique, the emitter emits a reference signal, also called a pilot signal. Such a reference signal is typically denoted CSI-RS in the 4G and 5G standards, for “Channel State Information—Reference Signal”. Upon receiving the reference signal, the receiver estimates on the one hand the transmitting channel between the emitter and the receiver (that is to say in the emitter to receiver direction), and on the other hand an interference covariance matrix, representative of the spatial structure of reception interference.

From the estimation of the transmitting channel between the emitter and the receiver and the spatial features of the interference, the receiver chooses the precoding matrix to be used by the emitter in the finite precoding dictionary. This precoding dictionary is generally defined by a standard, such as the 4G standard or the 5G standard. The receiver then sends this precoding choice back to the emitter via the limited return path, for example in the form of a “Precoding Matrix Indicator” (PMI) type indicator. The feedback of the precoding choice can optionally be accompanied by a channel quality indicator (CQI) and/or an indicator of the number of spatial layers (“Rank Indicator”, RI).

As an alternative to the CSI-D technique, it is possible to implement a technique, denoted CSI-R, which is based on the reciprocity of the channel between emitter and receiver (hence the R, for reciprocity). This reciprocity assumes that the transmitting channel between the receiver and the emitter (that is to say in the receiver to emitter direction) is the same as the transmitting channel between the emitter and the receiver (that is to say in the emitter to receiver direction). Here, the channel includes the effects of radio frequency channels which are not a priori reciprocal in emission and reception, but which can be calibrated to become so. The CSI-R technique thus assumes a use of the same frequency resources and a temporal separation of the upstream and downstream channels, or “Time Division Duplex”, (TDD).

According to the CSI-R technique, the receiver emits a reference signal, for example of the SRS type (for “Sounding Reference Signal”) in the 4G and 5G standards. From this reference signal, the emitter estimates the transmitting channel between the receiver and the emitter (that is to say in the receiver to emitter direction) and deduces by reciprocity the transmitting channel between the emitter and the receiver (that is to say in the emitter to receiver direction).

According to a first variant, denoted CSI-R1, from the estimation of the transmitting channel between the emitter and the receiver, the emitter can select a precoding matrix to be used. For example, the emitter determines a precoding matrix according to a criterion of maximizing the signal-to-noise ratio (SNR) or the predicted bit rate, neglecting the spatial structure of the interference (or covariance of the interference).

According to a second variant, denoted CSI-R2, the receiver estimates an interference covariance matrix and returns a compressed version of this interference covariance matrix to the emitter. This compressed version can for example take the form of the l largest eigenvalues of the covariance matrix (said matrix being of dimension N_{R}×N_{R}, where N_{R} is the number of reception antennas of the receiver). The interference covariance matrix being positive-definite, it is ortho-diagonalizable, and it is easy to deduce the eigenvalues thereof and order them.

However, none of these CSI-D, CSI-R1 or CSI-R2 techniques gives complete satisfaction, each having its share of disadvantages.

The CSI-R1 technique, although it allows the emitter to know the transmitting channel without quantification, does not allow the emitter to know the interference in reception. Indeed, such a technique determines the precoding matrix to be used by neglecting the spatial structure of the interference, the interference in reception not being reciprocal. It is then possible that the precoding in emission according to the CSI-R technique corresponds to directions where the interference is the strongest.

The return of the covariance of the interference from the receiver to the emitter according to this CSI-R1 technique is difficult to consider, because it would be too consuming in terms of the quantity of return path. The precoding matrix based on CSI-R1 is therefore obtained without taking into account the covariance of the interference or, which amounts to the same thing, by considering it unstructured.

The CSI-D and CSI-R2 techniques (respectively via a predetermined dictionary and via a return of a compressed version of the interference covariance matrix) do allow the emitter only to determine a quantized (therefore approximate) version of the precoding to be used. In the case of the CSI-D technique, this precoding comes from a predetermined precoding dictionary, and in the other case CSI-R2 this precoding is taken from an approximate version of the interference covariance matrix.

Furthermore, the emitter is subject to physical constraints on the emission power, the frequency sub-bands on which it can transmit, and on the number of spatial layers available, in particular for transmissions to several users. It is therefore important for the emitter to choose, at each time transmission interval, to which receivers it can transmit data, all without harming other receivers over time or compromising transmission performance. This choice is even more complex as the emitter can implement distinct techniques to acquire knowledge of the channel in the direction emitter to the different receivers (for example CSI-D type, CSI-R2 or CSI-R1 type).

There is therefore a need for a new approach in the selection of receivers to which to send data over time, in order to improve the transmission of information between an emitter and receivers, which does not have the disadvantages that each of the techniques described above have.

The development improves the situation.

### DESCRIPTION OF THE INVENTION

The development proposes a solution which does not have all these disadvantages, in the form of a communication method implemented in a transmission system comprising an emitter and a set of receivers. This method, implemented by the emitter, is remarkable in that it comprises, for at least one time-frequency resource:
receiving, from each of the receivers, at least one piece of information relating to a technique for acquiring knowledge of the transmit channel,
at least one of said information coming from one of said receivers being related to a first technique for acquiring knowledge of the transmit channel, and at least one of said information coming from another of said receivers being related to a second technique for acquiring knowledge of the transmit channel, and
selecting, from said information received from the receivers, a subset of receivers, included in the set of receivers, to which the emitter is configured to emit data on said at least one time-frequency resource,
said selection comprising determining said subset of receivers corresponding to an extremum of a performance metric.

Thus, this communication method is capable of simultaneously managing receivers configured to return to the emitter information relating to different techniques for acquiring knowledge of the transmit channel, this configuration of techniques being able to vary from one receiver to the other, and even for the same receiver over time.

These different techniques for acquiring knowledge of the transmit channel can be of the CSI-D, CSI-R1, CSI-R2 type for example. A receiver configured to return information relating to the CSI-i technique to the emitter is subsequently called a “CSI-i receiver”, with i of type D, R1 or R2. The emitter is thus capable of managing receivers with very heterogeneous CSI acquisition techniques.

Here, the selection criterion is thus based on the optimization of a so-called performance metric. This performance metric can be of the “proportional and fair” type, so as to allow both the bandwidth of the emitter to be maximized while ensuring a minimum quality of service which is satisfactory for each of the receivers. Alternatively, it could be possible to consider a performance metric on the total bandwidth of the emitter (so as to maximize the bit rate at the emitter output), called the “max C/l” metric.

In a particular embodiment, said at least one piece of information relating to a technique for acquiring knowledge of the transmit channel is a piece of information allowing the emitter to determine a precoding matrix taking into account the covariance matrix of the interference in reception according to said technique for acquiring knowledge of the transmit channel.

In a particular embodiment, the receiver selects a technique for acquiring knowledge of the transmit channel from a group of at least two techniques, including a technique based on a compressed version of an interference covariance matrix. In this way, the receiver can dynamically change CSI type.

The emitter can in particular decide on the scheduling scheme, that is to say select a subset of receivers sharing the same time-frequency resources, that is to say to which it can transmit data in the same time interval and on the same sub-band of frequency.

In one embodiment, said at least one piece of information allowing the emitter to determine a precoding matrix taking into account the covariance matrix of the interference in reception according to said technique for acquiring knowledge of the transmit channel belongs to the group comprising:
a compressed version of an interference covariance matrix, representative of the interference structure between receiver antennas;
at least one piece of information from a channel quality indicator (CQI), a number of spatial layers to be emitted (RI) and a precoding indicator (PMI).

For example, a receiver is of the CSI-R2 type if it returns a compressed version of an interference covariance matrix, representative of the spatial structure of the interference in reception, or of the CSI-D type if it provides a channel quality indicator (CQI), a number of spatial layers to be emitted (RI) and/or a precoding indicator (PMI)). Possibly, a receiver is of CSI-R1 type when it only sends an estimate of the channel in the emitter to receiver direction. Note that the receivers can change type over time, depending on the context, and return, for example, information relating to CSI-D for at least one time-frequency resource, and CSI-R2 type for at least one other time-frequency resource.

In one embodiment, the determination of the subset (K*) corresponding to an extremum of a performance metric comprises a construction of the subset by iteration on a current subset (K) initially empty, said construction comprising at least one iteration of the following steps:
selecting, from the set (Ω\K) of receivers outside the current subset (K), of a receiver (u*) whose incorporation into the current subset (K) maximizes the performance metric (R_{PF}), and
adding the selected receiver (u*) to the current subset (K) if the performance metric (R_{PF}) determined for the union (K U {u*}) of the current subset (K) and the selected receiver (u*) is greater than the performance metric determined for the current subset (K).

Here, the construction of a subset which corresponds to an extremum of the performance metric is carried out heuristically, by an iterative loop. This iterativity makes searching the subset for the performance metric much faster to execute than a brute force search, since the complexity decreases drastically. The inventors have established that the subset resulting from this heuristic construction is a good approach for the performance metric, and this subset will be called the quasi-optimal subset (K*) for the performance metric.

In one embodiment, the addition of said selected receiver (u*) to said current subset (K) further comprises:
a determination of the number of spatial layers (ν_{u*}) of said selected receiver (u*), and obtaining the number of spatial layers (ν_{K}) of the receivers of the current subset (K),
adding the selected receiver (u*) to the current subset (K) being carried out if the sum of the number of spatial layers (ν_{u*}) of said receiver and the number of spatial layers (ν_{K}) of the receivers of the current subset does not exceed a threshold Lₘₐₓ,
incrementing the number of spatial layers (ν_{u*}) of said receiver to the number of spatial layers (ν_{K}) of the receivers of the current subset (K) in the event of addition.

Here “number of spatial layers of a receiver” means the number of spatial layers allocated by the emitter for transmission to this receiver. Thus, the emitter can use ν_{u*} spatial layers for transmission to a receiver u*.

According to this embodiment, the sum of these spatial layers is limited to the threshold Lₘₐₓ.

This additional condition on the number of spatial layers prevents the addition of a receiver to the subset from saturating the number of spatial layers available for emission. Thus, here the constraints of the emitter and the receivers are integrated into the construction of the quasi-optimal subset.

In one embodiment, the method comprises interrupting the iteration loop in the absence of said addition of the selected receiver (u*) to the current subset (K) during an iteration. Thus, we leave the iteration at the moment when adding a new receiver to the current subset is no longer advantageous within the meaning of the performance metric and/or if this addition exceeds the number of available spatial layers. This interruption of the iteration loop avoids degrading emission performance by trying to include too many receivers. The emitter is thus quasi-optimal within the meaning of the performance metric, while respecting the spatial layer constraints above.

In one embodiment, the selection of the receiver (u*) whose addition to the current subset (K) maximizes the performance metric (R_{PF}) comprises
obtaining the performance metric for the current subset (K),
calculating, for at least one candidate receiver (u^{c}) outside the current subset (K), a candidate metric equal to the performance metric of the union of the current subset (K) and said candidate receiver (u^{c}), and
determining, as selected receiver (u*), the candidate receiver (u^{c}) having the largest candidate metric.

The calculation step can be carried out for all receivers outside the current subset. Alternatively, it could be possible to consider pre-sorting the external receivers, so as to reduce the complexity of the selection of the best candidate receiver, by eliminating (for the current best candidate selection cycle) the receivers for which it is obvious that they will not be good candidates.

In one embodiment, said at least one time-frequency resource associated with a sub-frame t and a sub-band k, the calculation of the candidate metric for the candidate receiver (u^{c}) comprises calculating a partial metric rᵤ(t) for each current receiver (u) belonging to the union of the current subset (K) and the candidate receiver (u^{c}), the candidate metric being equal to the sum of the calculated partial metrics, said calculation of the partial metric comprising
estimating a bit rate d_{u,k}(t) for the current receiver (u) for said sub-frame t and said sub-band k,
determining the average d̅ᵤ(t) of the bit rates d_{u,k′}(t) of the sub-bands k′ allocated to the current receiver (u) and the sub-bands still available,
obtaining an average bit rate wᵤ(t) weighted per sub-frame up to the previous sub-frame t−1, and
calculating the partial metric according to the equation rᵤ(t)=dᵤ(t)/[(1−β₁)wᵤ(t)+β₁d̅ᵤ(t)], where β₁ is a first parameter.

Here, a “proportional fair” metric, denoted PF metric is used. The objective of this performance metric is twofold: to maximize the bandwidth of the emitter, without harming the receivers, by ensuring a minimum quality of service (for example bit rate) for everyone. At each sub-frame, the emitter thus takes into account, for different receivers, their past bit rates (that is to say weighted average bit rates up to the previous sub-frame), their present bit rate (that is to say bit rate on the given sub-band and on the sub-bands already allocated) and their potential bit rates (bit rates on the sub-bands not yet allocated) to select the best possible receiver (within the meaning of the PF metric).

Weighting by the first parameter β₁ allows to finely adjust the weight given to past (synthesized in the function wᵤ(t)) and potential (synthesized in the average d̅ᵤ(t)) bit rates. In one embodiment, the average bit rate wᵤ(t) weighted per sub-frame is determined recursively for each receiver (u) of the set of receivers (Ω) by the initialization wᵤ(0)=0 and by the following recursion, where:
wᵤ(t)=(1−β₂)wᵤ(t−1)+β₂Dᵤ(t−1) if the receiver (u) belongs to the subset (K) at the sub-frame (t−1), where Dᵤ(t) is the bit rate for the sub-frame t and for all the sub-bands allocated to said receiver (u), Dᵤ(0)=0, and where β₂ is a second parameter,
wᵤ(t)=(1−β₂)wᵤ(t−1) if the receiver (u) does not belong to the subset (K) at the sub-frame t−1.

This recursive weighting by the second parameter β₂ allows to finely adjust the weight given to past bit rates (that is to say the weighted bit rate wᵤ(t−1)) and to the effective bit rate of the previous sub-frame (that is to say Dᵤ(t−1)). This second parameter β₂ may be different from the first parameter β₁ or equal.

In one embodiment, the estimation of the bit rate of d_{u,k}(t) for the current receiver (u) for the sub-band k at the sub-frame t comprises:
determining a multi-user signal-to-interference plus noise ratio SINR-MU γ_{u,l,k}^{(MU)} for the sub-band k and for at least one spatial layer 1 of the current receiver (u), from the information returned by the current receiver (u),
determining, from the SINR-MU γ_{u,l,k}^{(MU)} for the sub-band k and for the at least one spatial layer 1 of the current receiver (u), an effective SINR-MU γ_{u,k}^{(MU)} for the current receiver (u) and for the sub-band k,
determining, for the current receiver (u) and for the sub-band k, a modulation and coding scheme (MCS) from the effective SINR-MU γ_{u,k}^{(MU)} and a target error rate,
determining a bit rate d_{u,k}(t) for the current receiver (u) for the sub-band k from the modulation and coding scheme.

The bit rate is here determined using the physical properties of the receiver/emitter link, in particular the SINR-MU. This determination of the bit rate is based on a SINR-MU called effective SINR-MU, obtained by MIESM (“Mutual Information Effective SINR Mapping”) compression of the different SINR-MUs previously calculated for a given receiver and for a given sub-band. This effective SINR-MU synthesizes the SINR-MUs of the different spatial layers. Obtaining the modulation and coding scheme, starting from this SINR-MU, is carried out using Gaussian quality tables. This allows in practice to calculate the bit rate efficiently, as will be seen below.

In one embodiment, the calculation of the performance metric of the union (K∪{u^{c}}) of the current subset (K) and said candidate receiver (u^{c}) comprises
determining the precodings W to be applied to the receivers of said union (K∪{u^{c}}) based, for each receiver of said union, on the information returned by said receiver; and
determining, from the precodings W to be applied, a diagonal power allocation matrix P, each of the coefficients of which is a power P_{u,k,l} for the sub-band k and for a spatial layer 1 of one of the receivers (u) of said union (K∪{u^{c}}).

The determination of the SINR-MU γ_{u,l,k}^{(MU)}, for the sub-band k and for a spatial layer 1 of the current receiver (u), from the information returned by the current receiver (u) comprises:
if said information comprises a compressed version \hat{R}_{l,u} of the covariance matrix of the current receiver (u),
estimating a channel matrix H_{k,u} of the channel between the emitter and the current receiver (u),
determining a channel matrix after whitening the interference, denoted H_{0,u,k}, satisfying the equation H_{0,u,k}=R_{l,u}^{-1/2} H_{k,u},
determining the singular values (λ¹_{u,k}, . . . , λ¹_{u,k}, . . . , λ_{u,k}^{ν}^{ᵤ}) of the channel matrix after whitening the interference H_{0,u,k} by decomposition into singular values, each singular value being associated with a spatial layer 1 of the current receiver (u), and
determining the SINR-MU γ_{u,l,k}^{(MU)} for a spatial layer 1 of said receiver (u) on the sub-band k, from the singular value of said spatial layer 1 and the power P_{u,k,l} previously determined for said layer 1;
if said information comprises a channel quality indicator CQI(u,k,l) for the sub-band k and for the spatial layer 1 of the current receiver (u),
determining a SINR-SU γ_{u,k,l}^{□} for the spatial layer 1 from said channel quality indicator CQI(u,k,l), and
determining said SINR-MU γ_{u,l,k}^{(MU)} by renormalizing said SINR-SU γ_{u,k,l}^{□} by a ratio (P_{u,k,l}/P₀)P₁ between the power P_{u,k,l} previously determined for said layer 1 and P₀ the power P₀ used to calculate said channel quality indicator CQI(u,k,l).

In this embodiment, the calculation of the SINR-MU of a receiver is done in two stages. First of all, are calculated for all the receivers necessary for the subsequent calculations (that is to say all the receivers of the union (K∪{u^{c}}) of the current subset (K) and said candidate receiver (u^{c})), the precoding to be applied to each, and the resulting power allocation matrix. This allows to calculate the precodings and the power allocation matrix of the receivers of said union (K∪{u^{c}}) only once during the calculation of the metric of said union.

Then, when determining the SINR-MU of a given current receiver of said union (K∪{u^{c}}) (that is to say when calculating the partial metric of said current receiver), its SINR-MU is calculated on the basis of information returned by said receiver. The emitter is thus capable of estimating bit rates for receivers of variable type: CSI-D, CSI-R2 or a hybrid receiver whose type varies over time.

In one embodiment, determining the diagonal power allocation matrix P from the precodings W to be applied comprises determining the largest diagonal coefficient of the matrix WW^{†} and determining a power to be allocated to each of the layers on the basis of the ratio between a maximum power Pₘₐₓ per antenna of the emitter and said largest diagonal coefficient.

It is thus possible to assume a power which is equidistributed on the spatial layers, which allows a simple and explicit calculation of the coefficients of the power matrix, and consequently of the entire performance metric.

In one embodiment, determining the precodings W to be applied to the receivers of said union (K∪{u^{c}}) comprises
determining a channel matrix after whitening the interference (H₀) from the information returned by each receiver of said union,
decomposing into singular values the channel matrix after whitening the interference (H₀) thus determined into an input matrix Z,
constructing a precoding matrix W by selection of columns on a pseudo-inverse matrix M^{ZF} of the input matrix Z.

It is thus possible to construct a precoding matrix comprising precodings for the receivers of the union, even if the information coming from these receivers is heterogeneous (in other words, these receivers do not always have the same type, or even their type may change over time).

The development also proposes an emitter of a transmission system further comprising a set of receivers.

Such an emitter comprises, for at least one time-frequency resource:
means for receiving at least one piece of information relating to a technique for acquiring knowledge of the transmit channel, coming from each of the receivers,
at least one of said information coming from one of said receivers being related to a first technique for acquiring knowledge of the transmit channel, and at least one of said information coming from another of said receivers being related to a second technique for acquiring knowledge of the transmit channel,
means for selecting, from said information received from the receivers, a subset of receivers, included in the set of receivers, to which the emitter is configured to emit data on said at least one time-frequency resource,
said selection means comprising means for determining said subset of receivers corresponding to an extremum of a performance metric.

The development further proposes a computer program comprising instructions for implementing a method of the type described above, when this program is executed by a processor.

### LIST OF THE FIGURES

Other features and advantages of the development will appear more clearly upon reading the following description of a particular embodiment, given by way of simple illustrative and non-limiting example, and the appended drawings, among which:

FIG. 1 illustrates a transmission system comprising an emitter and receivers according to one embodiment of the development,

FIG. 2 illustrates the communication method according to one embodiment of the development,

FIG. 3 illustrates an example of selection step SEL1 carried out in the communication method of FIG. 2,

FIG. 4 illustrates another example of selection step SEL1 carried out in the communication method of FIG. 2,

FIG. 5 illustrates an example of selection step SEL2 carried out by selection step SEL1 of FIG. 3,

FIG. 6 illustrates an example of a calculation step carried out in the selection step SEL2 of FIG. 5,

FIG. 7 illustrates an example of a bit rate determination step carried out in the calculation step of FIG. 6,

FIG. 8 illustrates an example of a precoding determination step carried out in the selection step SEL2 of FIG. 5,

FIG. 9 illustrates an example of a SINR-MU determination step carried out in the bit rate determination step of FIG. 7, for a receiver in the CSI-D case,

FIG. 10 illustrates an example of a SINR-MU determination step carried out in the bit rate determination step of FIG. 7, for a receiver in the CSI-R2 case,

FIG. 11 schematically illustrates emitter-receiver exchanges for the CSI-D technique,

FIG. 12 schematically illustrates emitter-receiver exchanges for the CSI-R2 technique in an aperiodic case,

FIG. 13 schematically illustrates emitter-receiver exchanges for the CSI-R2 technique in a periodic case,

FIG. 14 illustrates the simplified structure of an emitter according to one embodiment of the development.

### Description of Embodiments of the Invention

### General Principle

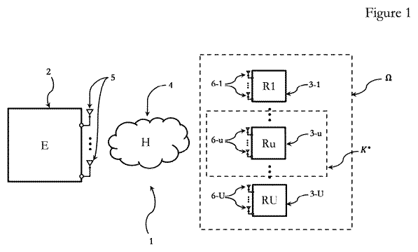

### Reference is Made to FIG. 1.

A transmission system 1 according to the development comprises an emitter 2 and a set Q of receivers 3-1 . . . 3-u . . . 3-U, in communication with the emitter via a global channel 4. Here, U is the number of receivers (also called “users”, hence the “U”)), and u is an integer comprised between 1 and U which is used to identify a receiver. For the following, a given receiver is designated by its index (1, . . . , u, . . . , U), or by the reference R-i (example: R1, . . . , Ru, RU where 1 . . . u . . . , U is the receiver index) depending on what is most readable in the context.

The emitter 2 may comprise N_{T} emitting antennas 5 (N_{T}>1), which may interfere with each other. Likewise, each receiver u can comprise N_{R}^{u} respective receiving antennas 6-u (N_{R}^{u}≥1), which can interfere with each other. By applying appropriate pre-coding, the emitter 2 can transmit data to several receivers on the same time-frequency resources, according to a scheduling scheme to be defined. In other words, the transmission system 1 is of the multi-user MIMO type.

Each of the receivers can send information to the emitter relating to a technique for acquiring knowledge of the transmit channel (“channel state information”, or CSI). Each of the receivers can be of the CSI-D type (that is to say return information of the PMI, RI and/or CQI type), of the CSI-R2 type (that is to say return a compressed version of the covariance matrix of the interference between its antennas), or of the CSI-R1 type for example. It is also possible to consider the use of receivers whose type varies over the transmissions. In this case, the receiver can select a technique for acquiring knowledge of the transmit channel, for example the one which would offer the best transmission rate for transmission on a given frequency band and time interval, and return to the emitter at least one piece of information relating to the selected technique; such receivers are for example described in the patent application filed in the name of Orange under number FR2114459.

It is not trivial to decide on the allocation of time-frequency resources to receivers, and in particular the corresponding scheduling scheme (that is to say to which receivers to allocate at least one time-frequency resource. This is especially true for the case that the set of receivers can be heterogeneous in terms of CSI acquisition technique.

The development proposes a method for satisfactorily selecting a subset of receivers K* from the set of receivers Q to which an emitter can emit data, for at least one given time-frequency resource. The subset of receivers K* is selected to be optimal, within the meaning defined below. In FIG. 1, the subset of selected receivers K* comprises for example the receiver Ru, but not the receiver R1, nor the receiver RU. In a particular embodiment, receivers are selected to emit on a sub-band k and a sub-frame t. A sub-frame t can be a set of OFDM symbols, for example 14 OFDM symbols in the 5G standard, some symbols used to transport useful data, others control data (“sub-frame”). If the context of the 5G standard is considered, a time-frequency resource is a “resource element” (RE). A resource element, in this context, denotes the smallest time-frequency granularity (that is to say, a subcarrier and an OFDM symbol).

It is considered that the reporting of a PMI and an RI by the receiver can only occur in a context where the number of emitting antennas at the emitter is N_{T}>1.

It is also noted that the number of spatial layers that a receiver can receive cannot exceed min(N_{T}, N_{R}^{u}). In the case of a single reception antenna at the receiver, the latter can only receive one spatial layer, or in other words RI=1. In the LTE (4G) standard, the number of reception antennas of a terminal called “smart phone” terminal is at least two while for the NR standard, the number of reception antennas for this type of terminal is specified at least at four antennas for certain bands (3.5 GHz n77/78). For base stations, the number of emitting antennas has continued to grow to reach up to 64 antennas in massive MIMO. Note that an antenna in this context is an RF chain including digital to analog conversion and vice versa. Thus, the number of radiating elements can be greater than the number of antennas. If the number of emitting and receiving antennas (or “transceiver units”) is the same at the base station, this is not the case for mobiles which may have a number of emitting antennas lower than the number of receiving antennas, typically two emitting antennas for four receiving antennas. However, the terminal can send reference signals from its four receiving antennas, even in this typical configuration, thanks to the technique called “antenna switching” (the RF chain is switched to another radiating element).

Note that when the receiver is equipped with a single receiving antenna for CSI-D, the number of spatial layers is limited to 1 (RI=1) and the covariance of the interference is a simple positive real scalar.

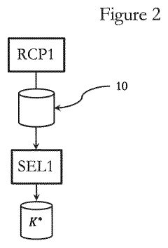

### Reference is Made to FIG. 2.

According to a particular embodiment, the communication method implemented in the emitter 2 comprises, for at least one time-frequency resource associated with a frequency sub-band k and a time sub-frame t, a step RCP1 of receiving at least one piece of information 10 relating to a CSI technique, coming from at least one receiver, and a step SEL1 of selecting a subset of receivers sharing the same time-frequency resources.

The information 10 coming from at least one receiver relates to a technique for acquiring knowledge of the transmit channel. Note that at least one receiver is configured to send information relating to a first technique (for example CSI-D, CSI-R1, CSI-R2), and at least one receiver is configured to send information relating to at least a second technique, distinct from the first technique.

The receiver sending information relating to the first technique and the receiver sending information relating to the second technique may be different (for example one receiver of CSI-D type and the other of CSI-R2 type for a given sub-frame) or be the same receiver for two distinct sub-frames (for example CSI-D at one time, and CSI-R2 at another time). In other words, the emitter is able to process the information coming from a receiver, regardless of whether this information relates to the first technique or to a second technique. Thus, the emitter can manage receivers of different types, or even of variable type over time.

In the CSI-R2 case, the information returned by the receiver u comprises a compressed version \hat{R}_{I} of the interference covariance matrix R_{I}. The interference covariance matrix R_{I} is representative of the spatial structure of the interference between the receiving antennas 6-u of a given receiver u (u being comprised between 1 and U). This compressed version \hat{R}_{I} of the interference covariance matrix R_{I} is obtained by the receiver u by estimating the interference covariance matrix R_{I} then compressing this interference covariance matrix R_{I}.

Here, the structure of the interference refers to the correlation of the interference on the different reception antennas for a subcarrier (given frequency) of an OFDM symbol for example. The interference will be qualified as “structured” when the covariance matrix of the interference deviates from an identity matrix (within a multiplicative factor), that is to say, when the correlation between the receiving antennas is strong.

According to a particular embodiment, the estimation of the interference covariance matrix is based on a configuration of CSI interference measurements (denoted CSI-IM). These CSI-IMs indicate resource element (or RE) positions where nothing is transmitted by the emitter, which gives a window for measuring interference without a signal from the emitter 2. In other words, the time-frequency positions (that is to say resource elements) where the covariance must be estimated correspond to CSI-RS of zero power, that is to say resource elements which are not used for transmission.

The estimation of the covariance matrix of the interference can be carried out by correlation of received signals representative of the interference on the different reception antennas 6-u of the receiver u, in the absence of CSI-RS reference signals. The emitter 2, for example, can configure resources (in time-frequency) prohibited for transmission (technique called “Zero-Power CSI-RS” in the 3GPP ZP-CSI-RS TS38.211 standard) which allow the receiver u to more easily measure, on these resources and for each reception antenna 6-u, the interference. Alternatively, it could be possible to consider estimating the interference covariance matrix from the subtraction of useful data or reference signals—that is to say not part of the interference from the point of view of the receiver in charge of measuring it—to the signals received on each antenna to obtain signals representative of the interference on the different reception antennas u.

In one embodiment, the covariance matrix is compressed by retaining only its largest eigenvalues. Indeed, as the matrix R_{I} is positive definite, it is ortho-diagonalizable (that is to say diagonalizable, and has eigenvectors orthogonal to each other). The eigenvalues of R_{I} are written in the form Sp(R_{I})=(λ₁, . . . , λₙ). It is then sufficient to keep the 1 largest eigenvalues.

Alternatively, it is possible to compress the covariance matrix of the interference such that R_{I}=α I_{N}_{_{R′}} by choosing α such that α∈ [symbol] ⁺ minimizes the difference

$${‖ {R}_{I} - {\hat{R}}_{I} ‖}^{2} = tr \{ {( {R}_{I} - \hat{{R}_{I}} )}^{†} ( {R}_{I} - {\hat{R}}_{I} ) \}$$

and belongs to a discrete subset of 2^{q} positive real elements. The compression of the interference covariance matrix is thus given by the transmission of q bits from the receiver to the emitter assuming that the discrete subset to which α belongs is known to the emitter and the receiver as well as the correspondence between the q bits received and the associated value of α.

In the CSI-D case, the information returned by the receiver u comprises for example a precoding indicator (PMI), identifying a precoding in the precoding dictionary. Said information may further comprise a channel quality indicator (CQI)—allowing in particular to deduce a modulation and coding scheme to be used for transmission, and/or a rank indicator (RI)—allowing to determine the number of spatial layers 1 to be used for transmission.

Step SEL1 comprises the selection, from said information received from the receivers, of a subset K* of receivers, included in the set Ω of receivers, sharing the same time-frequency resources.

The selection step SEL1 of the subset of receivers K* can be carried out by determining the subset of receivers K* (included in the set of receivers Ω) which maximizes a given performance metric. Performance metric means a function which associates a given real number with each subset of the set Ω. This metric allows to measure the extent to which a subset is relevant for a certain number of given criteria, such as for example transmission criteria (bit rates, error rate, SNR, etc.) and/or fairness criteria between the different receivers (so as not to harm any receiver over the different allocations of resource elements). A given subset is all the better, within the meaning of this metric, as the value of the subset metric is high if a metric based on a transmission rate or a signal-to-noise ratio is considered.

The emitter is then configured to simultaneously emit data on said sub-band to the receivers of this subset K* of receivers.

### Heuristic Construction Scheme

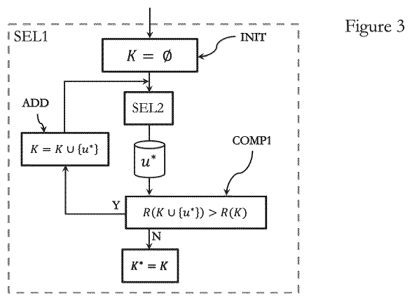

In one embodiment, shown in FIG. 3, the subset maximizing the performance metric, denoted R, is constructed iteratively, according to a heuristic scheduling scheme described below.

The iterative construction is carried out on a current subset K, which is initialized to the empty set Ø at the start of construction, in a step INIT. At each loop of the iteration, among the receivers external to this current subset K (that is to say not yet added to this current subset K) an optimal receiver u* to be added (optimal within the meaning of the selected performance metric) is determined. If this optimal receiver u* actually improves the performance metric, then this optimal receiver u* is added to the current subset K, and the operation is repeated until an optimal receiver u* of a given iteration no longer improves the performance metric of the current subset K. At this moment, the current subset K is an optimal or quasi-optimal subset for the performance metric.

More precisely, the construction comprises a selection SEL2 of the optimal receiver u* within the meaning of the performance metric among the set Ω\K of receivers external to the current subset K to be added to the current subset K, and a step ADD of adding (to “add”) the receiver u* if the performance metric R determined for the union K∪{u*} of the current subset K and the optimal receiver u* selected is greater than the performance metric determined for the current subset K.

Selected optimal receiver u* (optimal within the meaning of the performance metric) means a receiver of the set Ω\K whose “future” incorporation (that is to say incorporation at the end of the current iteration cycle) in the current subset (K) maximizes the performance metric R compared to the other receivers in the set Ω\K.

This optimal receiver may be unique. On the contrary, several receivers can provide the same “best” (for example the greatest) performance metric R once added to the current subset K. If several receivers are optimal within the meaning of the performance metric, it is possible to choose the one of the optimal receivers, for example randomly, or for example by preferring the one which has the fewest spatial layers.

Once the optimal receiver has been determined, it is determined during a step COMP1 whether it actually improves the metric of the union K∪{u*} of the current subset K and the selected optimal receiver u*—in other words, if R(K∪{u*})>R(K). If this is the case, this selected optimal receiver u* is added to the current subset K (in other words, K receives K∪{u*}, symbolized by K=K∪{u*} in the figures), and the previous operations are repeated.

### Condition on the Number of Spatial Layers

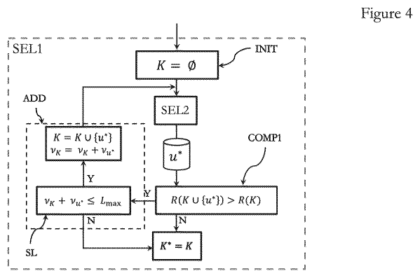

In one embodiment, shown in FIG. 4, the addition of the selected optimal receiver u* to said current subset K is carried out on the condition that the number of spatial layers of the union K∪{u*} of the current subset K and the selected optimal receiver u* does not exceed a threshold Lₘₐₓ. This threshold is for example M the number of transmitting antennas 5, since it is impossible to transmit more spatial layers than the number of transmitting antennas. Alternatively, it could be possible to consider having a threshold Lₘₐₓ equal to M−1, thus allowing to reserve a given spatial layer for another task parallel to MIMO-MU transmission.

More precisely, in this embodiment, the step ADD comprises determining the number of spatial layers ν_{u*} of said optimal receiver u*, and obtaining the number of spatial layers ν_{K} of the receivers of the current subset K, and a step of determining SL whether the sum of the number of spatial layers ν_{u*} of said receiver and the number of spatial layers ν_{K} of the receivers of the current subset is less than or equal to a predetermined threshold Lₘₐₓ.

If this condition is satisfied, then it can be proceeded by adding ADD the optimal receiver u* to the current subset K. The number of spatial layers ν_{u*} of said receiver is then incremented to the number of spatial layers ν_{K} of the receivers of the current subset (K) (in other words, ν_{K} receives ν_{K}+ν_{u*}, symbolized by ν_{K}=ν_{K}+ν_{u*} in the figures). This increment allows to avoid having to recalculate the number of spatial layers ν_{K} of the receivers of the current subset K in the next iteration loop.

If, on the contrary, this condition is not satisfied, then the addition ADD of the optimal receiver u* to the current subset K is not carried out.

Although FIG. 4 represents the verification of the stopping condition after the verification of the improvement of the metric, it is possible to carry out this step first, if it is more economical to discriminate the optimal receivers. In practice this can be faster.

### Stop Condition of the Heuristic Scheduling Scheme

During an iterative construction as described above, it generally happens that we come across an iteration where the optimal receiver (u*) selected is ultimately not added to the current subset K. This can be due to the fact that this optimal receiver (u*) does not improve the metric of the current subset K, or when this is implemented, that the union of the optimal receiver (u*) and the current subset K would not meet the condition on the maximum number of spatial layers. This may also be due to the fact that a receiver outside the current subset K (in other words, K=Ω) is no longer found. It is then appropriate to define an end of iteration.

In one embodiment, if an iteration loop does not comprise the addition step ADD, then it is considered that an optimal or quasi-optimal set K is reached. In this case, the iteration loop is interrupted. This provides a simple loop exit condition to be implemented in practice. This guarantees that from the moment when there is no optimal receiver (u*) whose addition to the current subset K improves the performance metric, the best current subset for this heuristic scheduling scheme is reached.

Furthermore, in the case where the condition on the number of layers is implemented, this guarantees a loop exit since an addition of a given optimal receiver u* to a given iteration loop necessarily increases the number of spatial layers of the current set K with a value greater than or equal to 1 (since ν_{u*}>0).

Alternatively, when the condition on the maximum number of spatial layers is implemented, it is possible to consider continuing the iteration loop when the optimal receiver u*, even if it actually improves the metric of the current subset (that is to say R(K∪{u*})>R(K)), does not satisfy the condition on the spatial layers. In this case, this certainly means that there are no longer enough spatial layers available to add the optimal receiver u*, but this does not exclude the existence of another receiver, outside the current subset K, which also improves the metric, while having fewer spatial layers than the optimal receiver u*. It is then possible to reiterate the iteration loop, in particular by executing the selection step SEL2 on all the receivers outside the union K∪{u*} of the current subset K and the optimal receiver u*, and test the condition again on the maximum number of spatial layers on a new optimal receiver outside this union K∪{u*}. If, through iterations, all the receivers outside the current subset K are “exhausted” without identifying a receiver which satisfies both the condition of improvement of the metric and the condition on the spatial layers, then this means that the subset K is quasi-optimal (for the metric), and the iteration can then be stopped and the current subset K can then be returned as the selected quasi-optimal subset K*.

### Determining the Optimal Receiver for the Performance Metric

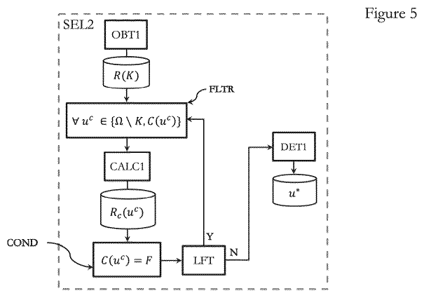

### Reference is Made to FIG. 5.

In one embodiment, the selection SEL2 of the optimal receiver u* within the meaning of the performance metric R comprises a step OBT1 of obtaining the performance metric for the current subset R(K), a step CALC1 of calculating, for at least one candidate receiver u_{c} of Ω\K (that is to say outside the current subset K), a candidate metric R_{c}(u^{c}) equal to the performance metric R(K∪{u^{c}}) of the union of the candidate receiver u_{c} with the current subset K, and finally a step DET1 of determining the candidate receiver u_{c} having the largest candidate metric R_{c}(u^{c}).

In one embodiment, during a step FLTR, the receivers are filtered in Ω\K according to a predetermined criterion (denoted C(u)), so as to effectively calculate the metric only for the most “promising” receivers for optimizing the metric, in other words for the receivers belonging to {Ω\K, C(u^{c})}. Once the calculation on a receiver has been carried out, it is then possible to modify, during a step COND, its corresponding criterion to set it to F (for “false”, in other words, to not recalculate its candidate metric). Then the calculation of the candidate metrics is continued for the remaining receivers {Ω\K,C(u^{c})}. This allows to accelerate the selection of the optimal receiver u*, by calculating only the necessary candidate metrics R_{c}(u^{c}).

For example, when the spatial layer condition is implemented, it is then possible to automatically exclude the receivers of Ω\K whose number of spatial layers is greater than the threshold Lₘₐₓ minus the number of spatial layers of the current subset K, since it is known in advance that these receivers will not fulfill said spatial layer condition. In other words, we have C(u^{c})=(νᵤ_{^{c}}>Lₘₐₓ−ν_{K}).

In an exemplary embodiment, all the receivers of Ω\K are tested as candidate receiver u_{c}. This ensures that the best receiver Ω\K is not missed. Here, this can be summarized as C(u^{c})=T (for “true”).

### “Proportional Fair” Metric

In one embodiment, the performance metric used is a metric called “proportional fair” metric, hereinafter denoted R_{PF} and called PF metric. This PF metric aims at maximizing the bandwidth of the emitter while guaranteeing a minimum quality of service for each receiver over time (or, in other words, a minimum bit rate averaged over time).

The calculation of the candidate metric R_{c}(u^{c}) of a candidate receiver u_{c} in the case of a PF metric may comprise a step CALC2 of calculating a partial metric rᵤ(t) for a given sub-frame t and for each current receiver u belonging to the union K∪{u^{c}}. The candidate metric is then equal to the sum of the partial metrics thus calculated:

$${R}_{c} ( {u}^{c} ) = {\sum }_{u ∈ K ⋃ \{ {u}^{c} \}} {r}_{u} ( t )$$

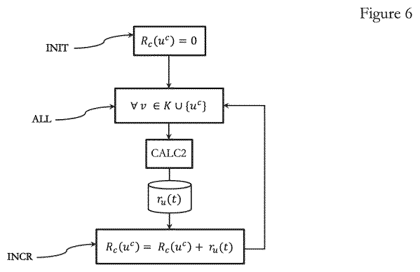

Reference is made to FIG. 6. In a step INIT the value of the candidate metric R_{c}(u^{c}) is initialized to zero, then a loop ALL is carried out on all the current receivers u of the union K∪{u^{c}}. During this loop, the partial metric is calculated in step CALC2, then the value of the candidate metric R_{c}(u^{c}) of the partial metric rᵤ(t) is incremented in a step INCR. The current value R_{c}(u^{c}) is then returned once the loop has been iterated over all the elements of K∪{u^{c}}.

The step CALC2 of calculating the partial metric, in the case of the PF metric, may comprise:
the estimation of a bit rate d_{u,k}(t) for the current receiver (u) for the sub-frame t and the sub-band k (on which it is sought to select the subset to which to emit),
determining the average d̅ᵤ(t) of the bit rates d_{u,k′}(t) of the sub-bands k′ allocated to the current receiver (u) and the sub-bands still available,
obtaining an average bit rate wᵤ(t) weighted per sub-frame up to the previous sub-frame t−1, and
calculating the partial metric according to the equation

$${r}_{u} ( t ) = {d}_{u} ( t ) / [ ( 1 - {β}_{1} ) {w}_{u} ( t ) + {β}_{1} {\overline{d}}_{u} ( t ) ] ,$$

where β₁ is a first parameter.

The general principle of this PF metric is thus to reserve a given sub-band for receivers having the most “need”—both because they have not been able to benefit from sufficient bit rate in the past (compared to other receivers), and/or because other possible sub-bands will not be as advantageous in terms of bit rates.

More precisely, the “proportional fair” metric favors a receiver u all the more as it can allow a significant bit rate on the considered sub-band. But, in return, the PF metric reduces the weight of the receivers u:
having already benefited from a significant bandwidth in the past (synthetized by the average bit rate wᵤ(t) weighted per sub-frame up to the previous sub-frame), and/or
having the possibility of having a significant bit rate on all the sub-bands still available—in other words, on the sub-bands other than the considered sub-band, which is synthesized by the average d̅ᵤ(t) of the bit rats of the sub-bands k allocated to the current receiver (u) and the sub-bands still available.

The calculation of the weighted average bit rate wᵤ(t) per sub-frame is determined recursively for each receiver u of the set of receivers Ω. It starts with the initialization wᵤ(0)=0 then a recursion is carried out depending on whether u belonged to the selected subset K* in the previous sub-frame t−1:
wᵤ(t)=(1−β₂)wᵤ(t−1)+β₂Dᵤ(t−1) if the receiver u belongs to the subset K* at the sub-frame t−1,
wᵤ(t)=(1−β₂)wᵤ(t−1) if the receiver u does not belong to the selected subset K* at the sub-frame t−1.

The term Dᵤ(t−1) corresponds to the bit rate for the sub-frame t−1 and for all the sub-bands allocated to said receiver (u), in other words the bit rate actually delivered to the receiver u in the previous sub-frame. This term Dᵤ(0)=0 is initialized, since no bit rate is transmitted before the start of the transmission method. The term β₂ is a second parameter comprised between 0 and 1.

Thus, if a given receiver u has belonged to the subset K* selected in the previous sub-frame t−1 (in other words, if it was selected and it benefited from a data transmission on the considered sub-band, or on another sub-band), its weighted average bit rate wᵤ increases in proportion to the total bit rate from which it has benefited. If, on the contrary, u was not included in the subset K* selected at the previous sub-frame t−1, then its weighted average bit rate wᵤ decreases (geometrically with the number of sub-frames without data transmission).

### Bit Rate Calculation (General Case)

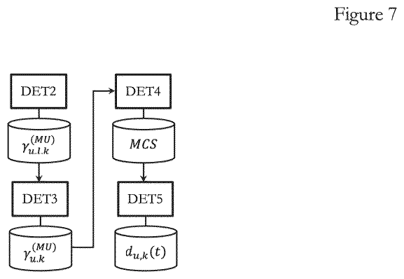

### Reference is Made to FIG. 7.

In order to calculate the PF metric, it is necessary to have access to the bit rate d_{u,k}(t) for the current receiver u for sub-band k at the sub-frame t. Depending on the type of receiver u (for example CSI-D, CSI-R1 or CSI-R2), the method for calculating this bit rate d_{u,k}(t) may differ. However, a significant part of the d_{u,k}(t) calculation process is common to the different types of receivers, and is described below.

Estimating the bit rate d_{u,k}(t) for the current receiver u for the sub-band k at the sub-frame t comprises determining one or more SINR-MU (signal-to-interference plus multi-user noise ratio, or “SINR multi users”) noted γ_{u,k,l}^{(MU)}, then the determination of an effective SINR-MU γ_{u,k,l}^{(MU)} (therefore without spatial layer index), the determination of a modulation and coding scheme (noted MCS), and finally the determination of a bit rate from this MCS.

The SINR-MU γ_{u,k,l}^{(MU)} is determined in a step DET2, for the sub-band k and for at least one spatial layer 1 of the current receiver u, from information returned by the current receiver u. The method for determining this SINR-MU γ_{u,k,l}^{(MU)} varies depending on the type of receiver, and the case of types CSI-D and CSI-R2 will be developed below.

The effective SINR-MU γ_{u,k}^{(MU)} is determined in a step DET3, for the current receiver u and for the sub-band k. Step DET3 is based on the SINR-MU(s) γ_{u,k,l}^{(MU)} determined in step DET2 for one or more spatial layers 1 of the current receiver u. The effective SINR is determined from the SINRs of each sub-band, via MIESM (“mutual information effective signal-to-noise-ratio mapping”) compression.

The modulation and coding scheme MCS is determined in a step DET4, for the current receiver u and for the sub-band k, from the effective SINR-MU γ_{u,k}^{(MU)}, determined in step DET3, and a target error rate BLER. More precisely, thanks to a physical layer abstraction technique, as presented in particular in the articles “Link performance models for system level simulations of broadband radio access systems” (K. Brueninghaus and al., IEEE 16th Int. Symposium on Personal, Indoor and Mobile Radio Communications, 2005 (PIMRC 2005), vol. 4, 2005, pp. 2306-2311) or “Realistic Performance of LTE: In a Macro-Cell Environment” (B. Landre and al. Proc. IEEE VTCS-2012, Japan, Yokohama, May 2012), the modulation and coding scheme can be determined on the basis of the effective SINR and a target error rate, using Gaussian quality tables.

The bit rate d_{u,k}(t) is determined in a step DET5, using a Gaussian quality table. Gaussian quality tables allow to empirically relate the effective SINR, a target error rate BLER and a modulation and coding scheme. The modulation and coding scheme allows to calculate the bit rate d_{u,k}(t). The bit rate d_{u,k}(t) is determined from the modulation (number of bits per symbol) and the “coding rate” (ratio of useful bits). In one embodiment, a target error rate BLER is set at 10% (or more generally less than 20%), which allows to deduce the modulation and coding scheme to be used, knowing the effective SINR. Then, this allows to obtain a bit rate for the considered technique (CSI-D, CSI-R1 or CSI-R2).

When the aim is to determine the bit rate Dᵤ(t−1) for the sub-frame t−1 and for all the sub-bands allocated to a receiver u, the step DET3 can also comprise an additional step wherein the SINR-MUs γ_{u,k,l}^{(MU)} are also compressed with respect to the allocated sub-bands k into an effective SINR-MU γᵤ^{(MU)} for the receiver u. In other words, a MIESM compression is applied to the sub-bands in order to obtain the effective SINR-MU γᵤ^{(MU)} Steps DET4 (to determine the MCS) and DET5 (to determine Dᵤ(t)) are then carried out similarly, step DET4 taking as input the effective SINR-MU γᵤ^{(MU)} thus determined.

Since, for a given sub-frame t, the candidate metric is calculated on the basis of the bit rate Dᵤ on all the sub-bands allocated to u at the previous sub-frame t−1, it is possible in practice to calculate the bit rate Dᵤ at the end of a given sub-frame and store it in memory so as not to have to recalculate all the SINR-MUs at the next sub-frame. In other words, the total bit rate Du can be calculated in parallel with the bit rates d_{u,k}(t), and store it for the next selection of the subset K* of receivers.

In order to determine the different bit rates of the different receivers of the union K∪{u^{c}}, SINR-MUs are calculated according to this embodiment for these receivers u. The calculation of these SINR-MU can be done in three steps: a calculation of the precoding to be applied to the receivers of the union K∪{u_{c}}, the determination of the power allocation for these receivers of the union K∪{u_{c}} from this precoding, and finally the determination of the SINR-MU of the receivers of the union K∪{u^{c}} from this power allocation.

### Calculation of Precoding and Power

In order to determine the different bit rates d_{u,k}(t), the calculation of the candidate metric (that is to say the union metric K∪{u^{c}}) comprises a step PREC of determining the precodings W=[W_{U}]_{u∈K∪{u}_{^{c}}_{}} to be applied for the receivers u of the union K∪{u^{c}}. Following this step PREC, a power matrix P representing the powers to be allocated to the different receivers u of the union K∪{u^{c}} is determined in a step PWR.

The step PREC takes as input the information returned by each of the receivers u (this differs depending on the type of receiver u).

The step PWR takes as input the precoding matrix W, and determines a power matrix P. The power matrix P is diagonal, and each of the coefficients is a power P_{u,k,l} for a spatial layer 1 of one of the receivers u of said union K∪{u^{c}}.

### Calculation of the Precoding for a Heterogeneous Set of Receivers

A method for calculating the precoding matrix to be applied, for a set U of receivers, is described below. During the step PREC, this calculation is carried out for U=K∪{u^{c}}. Considering U receivers scheduled simultaneously, the received signal vector is given by

$$y = {HWP}^{1 / 2} x + n$$

wherein:

$$y = {[ {y}_{1}^{T} , {y}_{2}^{T} , … , {y}_{U}^{T} ]}^{T} ∈ {ℂ}^{N \times 1}$$

N:=Σᵤ₌₁^{U} N_{R}^{u} is the total number of receiving antennas and N_{R}^{u} the number of antennas 6-u of the receiver u, M the number of transmitting antennas,
H the combined channel matrix H=[H₁ H₂ . . . Hᵤ]^{T} ∈ [symbol] ^{N×M}
x the data vector x=[x₁^{T}, x₂^{T}, . . . , x_{ν}^{T}]^{T}∈ [symbol] ^{ν} of which each component has a power normalized to 1
ν is the total number of transmitted spatial layers=Σᵤ₌₁^{U}νᵤ,
W is the pre-coding matrix W=[W₁ W₂ . . . W_{U}]∈ [symbol] ^{M×ν},
P∈ [symbol] ^{ν×ν} is a diagonal matrix each element of which represents the power per spatial layer, and
n=[n₁^{T}, n₂^{T}, . . . , n_{U}^{T}]^{T}∈ [symbol] ^{N×1} is the noise vector.

For a CSI-R2 type receiver u, the channel matrix after interference whitening is given by

$${H}_{0 , u} = {\hat{R}}_{u}^{I - 1 / 2} {H}_{u} ∈ {ℂ}^{{N}_{R}^{u} \times M}$$

with Hᵤ∈C^{N}^{_{R}}^{^{u}}^{×M} the channel matrix estimated by the emitter and \hat{R}ᵤ^{l} the compressed interference covariance matrix returned by the receiver u. The whitened channel matrix can then be decomposed into singular values (or SVD, “singular value decomposition”) in the following way:

$${H}_{0 , ιι} = {U}_{u} {Σ}_{u} {V}_{u}^{†} ∈ {ℂ}^{{N}_{R}^{u} \times M}$$

with Uᵤ∈ [symbol] ^{N}^{_{R}}^{^{u}}^{×N}^{_{R}}^{^{u}} containing the set of vectors called output eigenvectors, Vᵤ∈ [symbol] ^{M×N}^{_{R}}^{^{u}} containing the set of vectors called input eigenvectors and Σᵤ∈ [symbol] ^{N}^{_{R}}^{^{u}}^{×N}^{_{R}}^{^{u}} a square matrix containing the singular values on the diagonal coefficients.

For a CSI-D receiver u, the PMIᵤ sent to the emitter corresponds to a quantification \hat{V}ᵤ∈ [symbol] ^{M×N}^{_{R}}^{^{u}} of the matrix Vᵤ of the vectors called input eigenvectors of the whitened channel matrix

$${H}_{0 , ιι} = {R}_{u}^{I - 1 / 2} {H}_{u} = {U}_{u} {Σ}_{u} {V}_{u}^{†}$$

with Uᵤ∈ [symbol] ^{N}^{_{R}}^{^{u}}^{×N}^{_{R}}^{^{u}} containing the set of vectors called output eigenvectors, Vᵤ∈ [symbol] ^{M×N}^{_{R}}^{^{u}} containing the set of vectors called input eigenvectors and Σᵤ∈ [symbol] ^{N}^{_{R}}^{^{u}}^{×N}^{_{R}}^{^{u}} a square matrix containing the singular values on the diagonal coefficients. The number νᵤ of spatial layers of the receiver u is given by the indicator RI_{U} returned by this receiver.

The combined matrix of the whitened channel is given by H₀ with H₀=[H_{0,1} H_{0,2} . . . H_{0,U}]^{T}. Thus the vector of the received signal can be represented as follows:

$$y = {H}_{0} W {P}^{1 / 2} x + n$$

where n∈∈ [symbol] ^{N} is whitened [symbol] {nn^{†}}|=I_{N}( [symbol] being expectation). In reality, the noise plus interference is whitened per receiver but it is assumed below that the noise plus interference of the receivers are decorrelated because the receivers are spatially separated.

$$y = [ \begin{matrix}{H}_{0 , 1} \\ {H}_{0 , 2} \\ … \\ {H}_{0 , U}\end{matrix} ] [ {W}_{1} {W}_{2} … {W}_{U} ] {P}^{\frac{1}{2}} [ \begin{matrix}{x}_{1} \\ {x}_{2} \\ … \\ {x}_{U}\end{matrix} ] + [ \begin{matrix}{n}_{1} \\ {n}_{2} \\ … \\ {n}_{U}\end{matrix} ]$$

$$y = [ \begin{matrix}{U}_{1} {Σ}_{1} {V}_{1}^{†} \\ {U}_{2} {Σ}_{2} {V}_{2}^{†} \\ … \\ {U}_{U} {Σ}_{U} {V}_{U}^{†}\end{matrix} ] [ {W}_{1} {W}_{2} … {W}_{U} ] {P}^{\frac{1}{2}} [ \begin{matrix}{x}_{1} \\ {x}_{2} \\ … \\ {x}_{U}\end{matrix} ] + [ \begin{matrix}{n}_{1} \\ {n}_{2} \\ … \\ {n}_{U}\end{matrix} ]$$

$$y = [ \begin{matrix}{U}_{1} {Σ}_{1} & & 0 \\ & … & \\ 0 & & {U}_{U} {Σ}_{U}\end{matrix} ] [ \begin{matrix}{V}_{1}^{†} \\ {V}_{2}^{†} \\ … \\ {V}_{U}^{†}\end{matrix} ] [ {W}_{1} {W}_{2} … {W}_{U} ] {P}^{\frac{1}{2}} [ \begin{matrix}{x}_{1} \\ {x}_{2} \\ … \\ {x}_{U}\end{matrix} ] + [ \begin{matrix}{n}_{1} \\ {n}_{2} \\ … \\ {n}_{U}\end{matrix} ]$$

A “Zero Forcing” type technique is applied to the matrix Z=[V₁^{†}V₂^{†}. . . V_{U}^{†}]^{T}∈ [symbol] ^{N×M} and consists of pseudo-inverting this matrix:

$${M}^{Z F} = {{Z}^{†} ( {ZZ}^{†} )}^{- 1} ∈ {ℂ}^{M \times N}$$

and which can be expressed by M^{ZF}=[M₁^{ZF}M₂^{ZF} . . . M_{U}^{ZF}] with Mᵤ^{ZF}∈ [symbol] ^{M×N}^{_{R}}^{^{u}}. It should be noted that the matrix Z is a matrix combining the input matrices Vᵤ of each of the receivers u of U, this serving to make the expression of M^{ZF} more readable.

Thus, the matrix M^{ZF} allows to determine the precodings Wᵤ. More precisely, the precoding applied in MU-MIMO transmission to the receiver u corresponds to the νᵤ first columns of Mᵤ^{ZF}.

$${W}_{u} = ⌈ {M}_{u , 1}^{ZF} {M}_{u , 2}^{ZF} … {M}_{u , {ν}_{u}}^{ZF} ] ∈ {ℂ}^{M \times {ν}_{u}}$$

and the combined precoding matrix W=[W₁ W₂ . . . W_{U}]∈ [symbol] ^{M×ν} is where ν is the total number of transmitted spatial layers υ=Σᵤ₌₁^{U} υᵤ.

It can be noted that ZW∈ [symbol] ^{N×ν} is an identity matrix Iᵥ to which has been added, at each initial position (Σᵢ₌₁^{u}υᵢ), N_{R}^{u}-νᵤ null lines for all u∈{1, . . . , U}. In this ZW selects the first columns νᵤ of each matrix UᵤΣᵤ denoted Ũᵤ\tilde{Σ}ᵤ with \tilde{Σ}ᵤ=diag(λᵤ¹, . . . , λᵤ^{ν}^{ᵤ}).

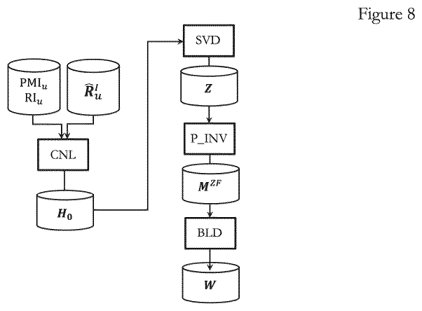

Reference is made to FIG. 8, which illustrates one embodiment of such a determination of the precoding W:
the information returned by each of the receivers u is received, this information may be heterogeneous; some receivers are of CSI-D type and return at least one RI and one PMI, other receivers are of CSI-R2 type and return a compressed version of the covariance matrix, still others can be of CSI-R1 type;
in a step CNL, a channel matrix after whitening the interference H_{0,u} is determined for each of the receivers u from the information coming from each of these receivers,
in a step SVD, each of the channel matrices after whitening the interference, H_{0,u} is decomposed into singular values, whereby input matrices Vᵤ are obtained, for each of the receivers u,
in a step P_INV, a pseudo-inversion is carried out on the matrix Z (combining the input matrices Vᵤ) to deduce a matrix M^{ZF}, and
in a step BLD the precoding W is constructed by selecting columns of the matrix M^{ZF}

Thus, thanks to this process, it is possible to aggregate the information returned by a set U of receivers u of different types (CSI-D, CSI-R2, and potentially other types such as CSI-R1) and deduce a precoding W for this set U.

Power from Precoding

[symbol]

The diagonal power matrix P∈ [symbol] ^{υ×ν} writes the power P₁ allocated per spatial layer 1 ε{1, . . . , ν}. Assuming that the spatial layers are transmitted at equal power P₁ P, the coefficient P is determined:

$$p = {min}_{m ∈ \{ 1 , … , M \}} \frac{{P}_{max}}{{[ {WW}^{†} ]}_{m , m}}$$

where [WW^{†}]_{m,m} is the m-th diagonal coefficient of the matrix WW^{\} and Pₘₐₓ the maximum power per transmitting antenna. Thus the received signal is given by the following expression:

$$y = \sqrt{P} [ \begin{matrix}{\tilde{U}}_{1} {\tilde{Σ}}_{1} & & 0 \\ & … & \\ 0 & & {\tilde{U}}_{U} {\tilde{Σ}}_{U}\end{matrix} ] [ \begin{matrix}{x}_{1} \\ {x}_{2} \\ … \\ {x}_{U}\end{matrix} ] + [ \begin{matrix}{n}_{1} \\ {n}_{2} \\ … \\ {n}_{U}\end{matrix} ]$$

It then remains to determine the SINR-MU of said receiver u. Here again, the steps to deduce this SINR-MU differ depending on the type of receiver.

### Calculation of the SINR-MU in the CSI-D Case

For a CSI-D receiver type, the matrix \tilde{Σ}ᵤ is deduced by “decompression” of the CQIᵤ received. The transition from a CQI_{u,k,l} to an effective SINR-SU can be carried out using a Gaussian table, representing the block error rate (BLER) as a function of the SNR corresponding to the modulation and coding scheme indicated by the CQI on a channel AWGN. The effective SINR-SU is the SINR necessary if a single receiver (“single user”) is considered to achieve a target BLER error rate (for example 10%) from this table.

In a first case, the CSI-D type receiver u can send a single CQI_{u,k} for the considered sub-band k, from which CQI_{u,k} it is possible to deduce a unique effective SINR-SU (SINR “single user”) γ_{u,k}^{(SU)} sometimes simply noted γᵤ^{□}, omitting the sub-band index. The matrix \tilde{Σ}ᵤ is then deduced, with P₀ the power of the reference signals used for the calculation of the CQI:

$${\tilde{Σ}}_{u} = [ \sqrt{{γ}_{u} / {P}_{0}} ] {I}_{{v}_{u}}$$

In a second case, the CSI-D type receiver u can send several CQI_{u,k,l} (one for each layer 1, for the considered sub-band k) from which are deduced effective SINR-SUs γ_{u,k,l}^{(SU)} per spatial layer (sometimes simply denoted γ_{u,k,l}^{□} or γ_{u,l}^{□} by omitting the sub-band index). It is then possible to deduce the matrix \tilde{Σ}ᵤ:

$${\tilde{Σ}}_{u} = diag ( \sqrt{{γ}_{u , 1} / {P}_{0}} , … , \sqrt{{γ}_{u , {v}_{u}} / {P}_{0}} )$$

The emitter knowing the SINRs per spatial layer for all the sub-bands can conventionally select the MCS (modulation and coding scheme) to be used for each receiver. It should be noted that it is not necessary to know the matrices Ũᵤ because they disappear by simple reception processing and they are not involved in the calculation of the SINR per spatial layer.

It is possible to deduce the SINR-MU γ_{u,k,l}^{(MU)} by renormalizing the SINR-SU by a factor P_{u,k,l}/P₀:

$${γ}_{u , k , l}^{( MU )} = ( {P}_{u , k , l} / {P}_{0} ) {γ}_{u , k , l}$$

between the power P_{u,k,l} (from the matrix P) and the power P₀ used to calculate said channel quality indicator CQI_{u,k,l}.

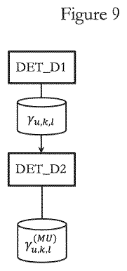

Reference is made to FIG. 9, which illustrates an embodiment of this determination of a SINR-MU when the receiver is of the CSI-D type. This determination of the SINR-MU γ_{u,k,l}^{(MU)}, for a sub-band k, and for a spatial layer 1 of the current receiver u, comprises:
a step DET_D1 of determining the SINR-SU yuk for the spatial layer 1 from at least one quality indicator of the channel CQI(u,k,l), and
a step DET_D2 of determining the SINR-MU γ_{u,k,l}^{(MU)} by renormalizing said SINR-SU γ_{u,k,l}^{□} by a ratio (P_{u,k,l}/P₀) between the power P_{u,k,l} previously determined for said layer 1 and the power P₀ used for calculating said channel quality indicator CQI(u,k,l).

### Calculation of the SINR-MU in the CSI-R2 Case

For the CSI-R2 case, the SINR-MU is calculated directly. This SINR-MU is determined, for a given sub-band k and for a spatial layer 1 of a CSI-R2 type receiver u, from the channel matrix H_{u,k} (obtained by channel reciprocity), and from the precoding applied to the receiver.

From the whitened channel H_{0,u,k}=\hat{R}_{I,u}^{-1/2}H_{k,u}, we obtain the matrix \tilde{Σ}ᵤ=diag(λᵤ¹, . . . , λᵤ^{ν}^{ᵤ}) is obtained thanks to the decomposition into singular values described above, on the channel matrix between the emitter and the type CSI-R2 receiver u of (where νᵤ is the number of spatial layers of said receiver u). The SINR for each spatial layer is then of the form γ_{u,l}^{(MU)}=P|λᵤ^{l}|².

As an illustration, the SINR of a linear receiver of the LMMSE-IRC type, for a sub-band k and a transmission of rank i, can be expressed in the form below (the receiver index u is omitted for more readability):

$${γ}_{k}^{i} ( {w}_{r , k}^{i} , {H}_{k} , {R}_{l} ) = \frac{{g}_{1}}{1 - {g}_{i}} ∀ i ∈ \{ 1 , … , v \}$$

where W_{r,k}ⁱ Hₖ, Rₗ are respectively a precoding matrix for a transmission of rank i on the sub-band k and on a resource element r, the channel matrix of sub-band k and the covariance matrix. As for gᵢ, it is defined by the expression below (where eᵢ is the i-th vector of dimension ν of the canonical basis, that is to say a vector with a coordinate 1 at the position i, and 0 elsewhere):

$${g}_{i} = {e}_{i}^{†} {σ}_{x}^{2} {w}_{r , k}^{†} {{H}_{k}^{†} ( {σ}_{x}^{2} {w}_{r , k}^{†} {H}_{k}^{†} {H}_{k} {w}_{r , k} + {R}_{I} )}^{- 1} {e}_{i}$$

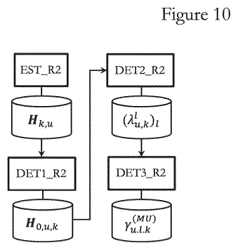

Reference is made to FIG. 10, which illustrates an embodiment of this determination of an SINR-MU in the CSI-R2 case. The determination of the SINR-MU of a current receiver u of type CSI-R2 comprises (\hat{R}_{I,u} designating the compressed version of the covariance matrix of the current receiver u):
a step EST_R2 of estimating a channel matrix H_{k,u} of the channel between the emitter and the current receiver u,
a step DET1_R2 of determining the channel matrix after whitening the interference, denoted H_{0,u,k}, satisfying the equation H_{0,u,k}=\hat{R}_{I,u}^{-1/2}H_{k,u}
a step DET2_R2 of determining the singular values (λ_{u,k}¹, . . . , λ_{u,k}^{l}, . . . , λ_{u,k}^{υ}^{ᵤ}) of the channel matrix after whitening the interference H_{0,u,k} by decomposition into singular values, each singular value being associated with a spatial layer 1 of the current receiver u, and
a step DET3_R2 of determining the SINR-MU γ_{u,l,k}^{(MU)} for a spatial layer 1 of said receiver u on the sub-band k, from the singular value of said spatial layer 1 and the power P_{u,k,l} previously determined for said layer 1.

### Periodicity and Aperiodicity of the Return of Information

In one embodiment, the feedback of information by a receiver u is carried out periodically and/or aperiodically, for example following a variation in the channel between said receiver u and emitter 2.

In the periodic case, the receiver u can in particular regularly emit a reference signal to the emitter 2, for example of the SRS (“Sounding Reference Signal”) type. In the aperiodic case, the receiver u can emit a reference signal upon receiving a request from the emitter 2, for example of the “SRS trigger command” type. This can be done at the request of the emitter 2 to the receiver u.

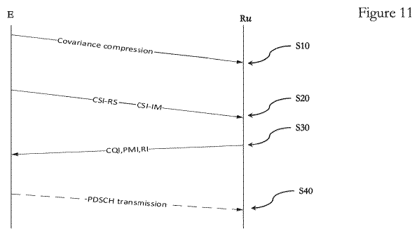

Reference is made to FIGS. 11 to 13, which schematically represent an order of exchanges between the receiver and the emitter. In FIGS. 11 to 13, the exchanges between emitter 2 and receiver u (here denoted E and Ru, respectively) can comprise, in order:
S10 (E to Ru) (optionally) sending an instruction on the method for compressing the covariance to be used for the receiver. The compression method can in particular be configured by the RRC layer in a semi-static manner,
S20 (E to Ru) sending CSI-RS and CSI-IM signals, so that the receiver Ru can estimate the covariance matrix and the channel matrix. These signals can be transmitted periodically or aperiodically,
S30 (Ru to E) sending information relating to the CSI technique considered for the receiver,
S40 (E to Ru) using the emission format, in particular the precoding defined from information relating to the technique considered for the receiver.

In the embodiment illustrated in FIG. 11, it is assumed that the receiver Ru is of the CSI-D type. The following steps can then be implemented:
S30 (Ru to E) sending information relating to the CSI technique considered for the receiver (here CSI-D, the information then comprising the PMI, and possibly CQI and RI),
S40 (E to Ru) using the emission format, in particular the precoding defined from the information relating to the technique considered for the receiver (here, CSI-D, the information being a PMI identifying the precoding to be implemented).

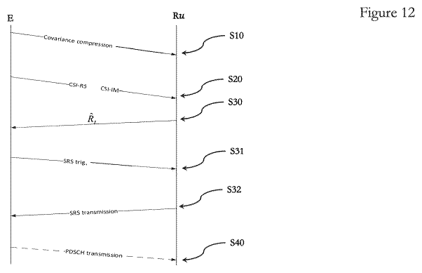

In the embodiment illustrated in FIG. 12, it is assumed that the receiver Ru is of the CSI-R2 type. It is also assumed that the receiver Ru transmits a reference signal SRS aperiodically, for example in response to a request from the emitter E.

In this case, the following steps can be implemented:
S30 (Ru to E) sending information relating to the CSI technique considered for the receiver (here CSI-R2, the information being the compressed version of the interference covariance matrix \hat{R}_{I}, compressed according to the method M indicated by the emitter, if applicable),
S31 (E to Ru) requesting (from the emitter) for transmission of a reference signal SRS
S32 (Ru to E) emitting a reference signal SRS (used for channel estimation by the emitter), in response to the request of step S31
S40 (E to Ru) using the emission format, in particular the precoding defined from the information relating to the technique considered for the receiver (here, CSI-R2, and the precoding implemented is determined on the basis of the compressed version of the interference covariance matrix and on the channel matrix estimated using to the reference signal SRS).

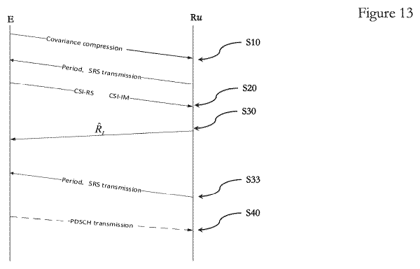

In the embodiment illustrated in FIG. 13, it is assumed that the receiver Ru is also of the CSI-R2 type. It is also assumed that the receiver transmits a reference signal SRS periodically.

The exchanges between the emitter 2 and the receiver Ru are similar to those of the aperiodic case shown in FIG. 9, with the exception of steps S31 and S32 which are replaced by a step S33:
S33 (Ru to E) emission of a reference signal SRS (used for channel estimation by the emitter), periodically.

In the embodiments illustrated in FIGS. 12 and 13, the emitter E can use the most recent reference signal SRS to estimate the channel.

### Devices

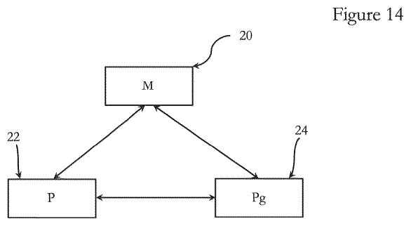

Finally, the simplified structure of an emitter according to one embodiment of the development is presented in relation to FIG. 14.

As illustrated in FIG. 14, an emitter according to one embodiment of the development comprises a memory 20, a processing unit 22, equipped for example with a programmable calculation machine or with a dedicated calculation machine, for example a processor P, and controlled by the computer program 24, implementing steps of the communication method according to at least one embodiment of the development.

Upon initialization, the code instructions of the computer program 24 are for example loaded into a RAM memory before being executed by the processor of the processing unit 22.

The processor of the processing unit 22 implements steps of the communication method described above, according to the instructions of the computer program 24, to:
receive, from each of the receivers, at least one piece of information relating to a technique for acquiring knowledge of the transmit channel,
at least one of said receivers being configured to return to said emitter information relating to a first technique for acquiring knowledge of the transmit channel, and at least one of said receivers being configured to return to said emitter information relating to a second technique for acquiring knowledge of the transmit channel,
select, from said information received from the receivers, a subset (K*) of receivers, included in the set (Ω) of receivers, to which the emitter is configured to simultaneously emit data on said at least one time-frequency resource.

### Variants

A PMI, CQI and/or RI return has been described for a CSI-D type receiver, for a given sub-band. However, granularity on the sub-band (that is to say the returning several CQIs for a given sub-band, for example) can be considered.

The CQI gives the coding efficiency r and the modulation carrying q bits (or the modulation and coding scheme) and the RI gives the number of spatial layers per sub-band. It follows that the estimated bit rate in this case for a sub-band of resource elements N_{RE} is dᵤ(t)=rqN_{RE}. If the return of CQI, PMI, RI is done with a granularity lower than the sub-band, for example two pairs of PMI, CQI per sub-band (CQI₁, PMI₁, RI) and (CQI₂, PMI₂, RI), then it is necessary to decompress CQI₁ and CQI₂ each into a number RI of SINR (which correspond to a reading of the quality table associated with the MCS which gives the SINR necessary to achieve a packet error rate of 10%) then to apply the abstraction of the physical layer as described in part “Bit rate calculation” above, to find after MIESM compression the (CQIᵣₑₛ, PMIᵣₑₛ, RI) adapted to the sub-band which gives the bit rate dᵤ(t) as previously.

A “proportional fair” metric was described to determine the subset of receivers K*. However, alternatively it is possible to consider different metrics, for example of the max C/I type, which aims at maximizing the transmitted bit rate without taking into account the fairness criteria of the PF metric.

An emitter and receivers each comprising several antennas were described. As an example and order of magnitude, a receiver in the 5G standard typically comprises four antennas. The development also works when at least one of the receivers has only one antenna. In this case, several matrices used in the development are scalars (for example the interference covariance matrix and its compressed version).

A way has been described of selecting receivers to which to emit on at least one time-frequency resource, for example on a frequency sub-band and a sub-frame. In a particular embodiment, the development can be implemented to select receivers in order to transmit over a time transmission interval (TTI) different from one sub-frame or several sub-frames (for example over half a sub-frame). It is thus possible to consider a time transmission interval as a set of OFDM symbols corresponding to the temporal granularity of time-frequency resource allocation for a given receiver.

For example, in the TS36.211/T38.211 standard, a time transmission interval can be a “slot” of 14 OFDM symbols whose duration is 1 ms for a spacing between carriers 15 kHz, or 0.5 ms for 30 kHz spacing between carriers. In the case of transmission to several receivers, a time transmission interval conventionally contains a “unicast” control channel to each receiver, this control channel indicating to each receiver its time-frequency allocation, that is to say the symbols OFDM and the subcarriers (or sub-bands) of the time transmission interval allocated thereto to receive its data. It can thus be considered that, knowing the implementation of the control channels, the time resource allocation is the same for all receivers scheduled simultaneously and for all time transmission intervals. In other embodiments, other definitions of the time transmission interval may be considered.

1. A communication method implemented in a transmission system comprising an emitter and a set (Ω) of receivers, characterized in that said method comprises, for at least one time-frequency resource:
receiving, from each of the receivers, at least one piece of information relating to a technique for acquiring knowledge of a transmit channel,
at least one of said information coming from one of said receivers being related to a first technique for acquiring knowledge of the transmit channel, and at least one of said information coming from another of said receivers being related to a second technique for acquiring knowledge of a transmit channel,
selecting, from said information received from the receivers, of a subset (K*) of receivers, included in the set (Ω) of receivers, to which the emitter is configured to emit data on said at least one time-frequency resource,
said selection comprising determining said subset (K*) of receivers corresponding to an extremum of a performance metric.

2. The method according to claim 1, characterized in that said at least one piece of information relating to a technique for acquiring knowledge of the transmit channel is a piece of information allowing the emitter to determine a precoding matrix taking into account a covariance matrix of an interference in reception according to said technique for acquiring knowledge of the transmit channel.

3. The method according to claim 2, characterized in that said at least one piece of information allowing the emitter to determine a precoding matrix taking into account the covariance matrix of the interference in reception according to said technique for acquiring knowledge of the transmit channel belongs to the group comprising:
a compressed version (\hat{R}_{I}) of an interference covariance matrix (R_{I}), representative of a spatial structure of the interference between antennas of the receiver;
at least one piece of information from a channel quality indicator, a number of spatial layers to be emitted (RI) and a precoding indicator.

4. The method according to claim 1, characterized in that the determination of the subset (K*) corresponding to an extremum of a performance metric comprises a construction of the subset by iteration on a current subset (K) initially empty, said construction comprising at least one iteration of steps including:
selecting, from the set (Ω\K) of receivers outside the current subset (K), of a receiver (u*) whose incorporation into the current subset (K) maximizes the performance metric (R_{PF}), and
adding the selected receiver (u*) to the current subset (K) if a performance metric (R_{PF}) determined for a union (K∪{u*}) of the current subset (K) and the selected receiver (u*) is greater than a performance metric determined for the current subset (K).

5. The method according to claim 4, wherein addition of said selected receiver (u*) to said current subset (K) further comprises:
determining a number of spatial layers (ν_{u*}) of said selected receiver (u*), and obtaining a number of spatial layers (νₖ) of the receivers of the current subset (K),
adding the selected receiver (u*) to the current subset (K) being carried out if a sum of the number of spatial layers (ν_{u*}) of said receiver and the number of spatial layers (νₖ) of the receivers of the current subset does not exceed a threshold Lₘₐₓ,
incrementing the number of spatial layers (ν_{u*}) of said receiver to the number of spatial layers (νₖ) of the receivers of the current subset (K) in response to addition.

6. The method according to claim 4, comprising interrupting the at least one iteration when the selected receiver (u*) is not added to the current subset (K) during an iteration.

7. The method according to claim 4, characterized in that the selection of the receiver (u*) whose addition to the current subset (K) maximizes the performance metric (R_{PF}) comprises
obtaining the performance metric (R(K)) for the current subset (K),
calculating, for at least one candidate receiver (u^{c}) outside the current subset (K), of a candidate metric (R_{c}(u^{c})) equal to the performance metric of the union of the current subset (K) and said candidate receiver (u^{c}), and
determining, as selected receiver (u*), the candidate receiver (u^{c}) having a largest candidate metric (R_{c}(u^{c})).

8. The method according to claim 7, characterized in that said at least one time-frequency resource is associated with a sub-frame (t) and a sub-band (k), and in that the calculation of the candidate metric (R_{c}(u^{c})) for the candidate receiver (u^{c}) comprises calculating a partial metric (rᵤ(t)) for each current receiver (u) belonging to the union of the current subset (K) and the candidate receiver (u_{c}), the candidate metric (R_{c}(u^{c})) being equal to a sum of the calculated partial metrics (rᵤ (t)), said calculation of the partial metric (rᵤ (t)) comprising
estimating a bit rate d_{u,k}(t) for the current receiver (u) for said sub-frame (t) and said sub-band (k),
determining an average d̅ᵤ(t) of the bit rates d_{u,k′}(t) of sub-bands (k′) allocated to the current receiver (u) and the sub-bands not yet allocated,
obtaining an average bit rate wᵤ(t) weighted per sub-frame up to a previous sub-frame (t−1), and
calculating the partial metric according to an equation rᵤ(t)=dᵤ(t)/[(1−β₁)wᵤ(t)+β₁d̅ᵤ(t)], where β₁ is a first parameter.

9. The method according to claim 8, characterized in that the average bit rate wᵤ(t) weighted per sub-frame is determined recursively for each receiver (u) of the set of receivers (Ω) by an initialization wᵤ(0)=0 and by recursion as follows, where:
wᵤ(t)=(1−β₂)wᵤ(t−1)+β₂Dᵤ(t−1) if the receiver (u) belongs to the selected subset (K*) at the previous sub-frame (t−1), where Dᵤ(t) is the bit rate for the sub-frame t and for all the sub-bands allocated to said receiver (u), Dᵤ(0)=0, and where β₂ is a second parameter,
wᵤ(t)=(1−β₂)wᵤ(t−1) if the receiver (u) does not belong to the selected subset (K*) at the previous sub-frame t−1.

10. The method according to claim 8, wherein the estimation of the bit rate d_{u,k}(t) for the current receiver (u) for the sub-band (k) at the sub-frame t comprises:
determining a SINR-MU γ_{u,k,l}^{(MU)} for the sub-band (k) and for at least one spatial layer 1 of the current receiver (u), from the information coming from the current receiver (u),
determining, from the SINR-MUγ_{u,l,k}^{(MU)} previously determined for the sub-band (k) and for said at least one spatial layer (1) of the current receiver (u), an effective SINR-MU γ_{u,k}^{(MU)} for the current receiver (u) and for the sub-band (k),
determining, for the current receiver (u) and for the sub-band (k), a modulation and coding scheme from the effective SINR-MU γ_{u,k}^{(MU)} and a target error rate,
determining a bit rate d_{u,k}(t) for the current receiver (u) for the sub-band (k) from the modulation and coding scheme.

11. The method according to claim 10, characterized in that the calculation of the performance metric of the union (K∪{u^{c}}) of the current subset (K) and said candidate receiver (u^{c}) comprises
determining precodings W to be applied to the receivers of said union (K∪{u^{c}}) based, for each receiver of said union, on the information coming from said receiver; and
determining, from the precodings W to be applied, a diagonal power allocation matrix P, each coefficients of which is a power P_{u,k,l} for a spatial layer (1) of one of the receivers (u) of said union (K∪{u^{c}};
and in that the determination of the SINR-MU γ_{u,l,k}^{(MU)}, for the sub-band (k) and for a spatial layer (1) of the current receiver (u), from the information coming from the current receiver (u) comprises:
if said information comprises a compressed version \hat{R}_{I,u} of a covariance matrix of the current receiver (u),
estimating a channel matrix H_{k,u} of the channel between the emitter and the current receiver (u),
determining a channel matrix after whitening an interference, denoted H_{0,u,k}, satisfying the equation H_{0,u,k}=R_{I,u}^{-1/2}H_{k,u},
determining singular values of the channel matrix after whitening the interference H_{0,u,k} by decomposition into singular values, each singular value being associated with a spatial layer (1) of the current receiver (u), and
determining the SINR-MU γ_{u,l,k}^{(MU)} for a spatial layer 1 of said receiver (u) on the sub-band (k), from the singular value of said spatial layer (1) and the power P_{u,k,l} previously determined for said layer (1);
if said information comprises a channel quality indicator for the sub-band (k) and for the spatial layer (1) of the current receiver (u),
determining a SINR-SU γ_{u,k,l}^{□}, for the spatial layer (1) from said channel quality indicator, and
determining said SINR-MU γ_{u,l,k}^{(MU)} by renormalizing said SINR-SU γ_{u,k,l}^{□}, by a ratio between the power Pu,k,l previously determined for said layer (1) and a power P0 used to calculate said channel quality indicator.

12. The method according to claim 11, wherein determining the diagonal power allocation matrix P from the precodings W to be applied comprises determining a largest diagonal coefficient of the matrix WW^{†} and determining a power to be allocated to each of the layers according to a ratio between a maximum power Pₘₐₓ per antenna of the emitter and said largest diagonal coefficient.

13. The method according to claim 11, wherein determining the precodings W to be applied to the receivers of said union (K∪{u^{c}}) comprises
determining a channel matrix after whitening the interference (H_{0,u}) for each of the receivers (u) of said union from the information coming from each receiver of said union,
decomposing into singular values each of a plurality of channel matrices after whitening the interference (H_{0,u}) thus determined into input matrices Vᵤ,
constructing a precoding matrix W by selection of columns from the input matrices Vᵤ.

14. An emitter of a transmission system further comprising a set (Ω) of receivers, characterized in that said emitter comprises, for at least one time-frequency resource:
means for receiving at least one piece of information relating to a technique for acquiring knowledge of a transmit channel, coming from each of said receivers,
at least one of said information coming from one of said receivers being related to a first technique for acquiring knowledge of the transmit channel, and at least one of said information coming from another of said receivers being related to a second technique for acquiring knowledge of the transmit channel,
means for selecting, from said information received from the receivers, a subset (K*) of receivers, included in the set (Ω) of receivers, to which the emitter is configured to emit data on said at least one time-frequency resource
said selection means comprising means for determining said subset of receivers (K*) corresponding to an extremum of a performance metric.

15. A computer program (Pg) including instructions for implementing a method according to claim 1 when this program is executed by a processor (P).
